(19) United States
(12) Patent Application Publication
(10) Pub. No.: US 2016/0203449 A1
(43) Pub. Date: Jul. 14, 2016

(54) Multiple Merchant Credit System and Method

(71) Applicant: Gopal Nandakumar, San Antonio, TX (US)

(72) Inventor: Gopal Nandakumar, San Antonio, TX (US)

(21) Appl. No.: 14/994,020

(22) Filed: Jan. 12, 2016

Related U.S. Application Data
(60) Provisional application No. 62/102,771, filed on Jan. 13, 2015.

(51) Int. Cl. G06Q 20/10; G06Q 20/24; G06Q 40/02

(52) U.S. Cl. CPC G06Q 20/102; G06Q 40/02; G06Q 20/24

(57) ABSTRACT

A credit accounting system that can be used by consumers (end users) with unlimited number of merchants (service clients) and funded by participating merchants. The system generally includes a means for consumers to establish a single credit account that can be accepted by unlimited number of merchants and the account is funded by participating merchants based on the total outstanding account balance broken by individual merchants.

### CROSS REFERENCE TO RELATED APPLICATIONS

This original application claims priority to and the benefit of U.S. provisional application Ser. No. 62/102,771, filed Jan. 13, 2015, and which is incorporated by reference.

### STATEMENT REGARDING FEDERALLY SPONSORED RESEARCH OR DEVELOPMENT

Not applicable.

### BACKGROUND OF THE INVENTION

1. Field of the Invention

The present invention relates to a consumer revolving credit account that can be used with multiple merchants and funded by merchants based on the total outstanding account owed by individual merchants. More particularly, the invention relates to a system and related method whereby a revolving credit account that would support ‘Get Paid When Paid’ technology. Merchants would be paid only when consumers make payment.

2. Description of the Related Art

Accepting credit cards is an essential part of any business, because it provides unique convenience for consumers and merchants. Consumers do not have to carry cash, can make a single payment, set up budgets, etc. This translates into increased sales for merchants.

There are two types of credit cards. One is funded by financial institutions, which can be used with multiple merchants. The other is funded by a single merchant and can be used only with that single merchant.

But the ever-increasing cost of accepting credit cards issued by financial institutions is a concern for businesses. For some businesses, this cost is one of the major costs of doing business. There are many reasons for this ever-increasing cost—for example, the layers of entities involved in this process and the competition between financial institutions to give more awards to consumers. Each entity has a vested interest in sharing the revenue. Some of the entities are sales people, individual service organizations, processors, acquirers, networks, issuers and rewards providers.

The cost borne by the merchants is divided into a discount fee and an interchange fee. Usually the discount fee is fixed whereas the interchange fee varies depending on the rewards awarded to the card holders. Most of the rewards have no value for merchants, yet the cost is passed on to merchants.

Most of the credit account holders do not carry balances. Where there are no balances carried over, the credit card issuer advances the payment to merchant for not more than 30 days. At a total credit card fee of 3%, this translates into a minimum of 36% annualized rate of Finance Charges for the merchants. This is far more than any merchant would normally pay for any loan. Also many merchants cannot wait 30 days to receive the payment.

When the credit account holders carry balances, they pay a hefty finance charge, which is not shared by the credit card issuers with any other entity, including merchants.

In order to cut down the cost of accepting credit cards, some merchants issue their own credit cards. But this is not widely accepted by consumers because the consumers have to set up credit account with each individual merchant. Consumers can qualify only for a certain credit amount that can be used in all credit accounts. As consumers participate in more credit accounts the available amount to open other credit accounts diminishes and eventually they cannot open any more credit accounts. Also, consumers' credit scores depends on their total liability. A higher liability results in a lower credit score and higher finance-charge rate. Moreover, consumers may not use all the available limits in all the credit accounts simultaneously. So, establishing credit accounts with individual merchants is not a viable option for many consumers.

Given the fundamentally flawed state of the art with respect to revolving credit accounts, it is therefore the overriding object of the present invention to improve the prior art by providing a system and related method by which merchants can accept credit cards at a substantially lower cost and consumers can qualify to establish credit accounts without jeopardizing their credit scores. For sake of clarity, credit accounts that can be used with multiple merchants and funded by financial institutions and credit accounts that can be used with a single merchant and funded by single merchant would be referred as “traditional” credit accounts.

### BRIEF SUMMARY OF THE INVENTION

In accordance with the foregoing objects, the present invention—a credit accounting system that can be used by consumers (end users) with unlimited number of merchants (service clients) and funded by participating merchants—generally comprises a means for consumers to establish a single credit account that can be accepted by unlimited number of merchants and the account is funded by participating merchants based on the total outstanding account balance broken by individual merchants. For the sake of clarity, this credit account funded by the participating multi-merchants as per the present invention would be referred as an “innovative” credit account.

### BRIEF DESCRIPTION OF THE SEVERAL VIEWS OF THE DRAWINGS

FIG. 1 shows calculation of a finance charge for a traditional account using the adjusted balance method.

FIG. 2 shows calculation of finance charges using the present invention and the adjusted balance method.

FIG. 3 shows calculation of a finance charge for a traditional account using the average daily balance method.

FIG. 4 shows calculation of finance charges using the present invention and the average daily balance method.

FIG. 5 shows calculation of a finance charge for a traditional account using the daily balance method.

FIG. 6 shows calculation of finance charges using the present invention and the daily balance method.

FIG. 7 shows calculation of a finance charge for a traditional account using the double billing cycle method.

FIG. 8 shows calculation of finance charges using the present invention and the double billing cycle method.

FIG. 9 shows calculation of a finance charge for a traditional account using the ending balance method.

FIG. 10 shows calculation of finance charges using the present invention and the ending balance method.

FIG. 11 shows calculation of a finance charge for a traditional account using the previous balance method.

FIG. 12 shows calculation of finance charges using the present invention and the previous balance method.

FIG. 13 shows distributions for a traditional account involving a non-performing loan.

FIG. 14 shows distributions using the present invention for a non-performing loan.

FIG. 15 shows, in an overview user case diagram, the various basic functionality implemented in the preferred embodiment of the credit accounting system and method of the present invention.

FIG. 16 shows, in a flow chart, an overview of the various steps generally taken in adding a service client in accordance with the present invention.

FIG. 17 shows, in a flow chart, an overview of the various steps generally taken in adding an end user in accordance with the present invention.

FIG. 18 shows, in a flow chart, an overview of the various steps generally taken in providing a means for the end user to use the available credits to purchase goods and services from service clients in accordance with the present invention.

FIG. 19 shows, in a flow chart, an overview of the various steps generally taken in providing a means for the end user to make payment to the service provider in accordance with the present invention.

FIG. 20 shows, in a flow chart, an overview of the various steps generally taken in providing a means for the service provider to perform database maintenance for end of billing cycle and to send billing statements to end users in accordance with the present invention.

FIG. 21 shows, in a class diagram, a high level schema for a representative end user database as may be implemented in connection with the exemplary hardware and software implementation of FIG. 15.

FIG. 22 shows, in a class diagram, a high level schema for a representative service client database as may be implemented in connection with the exemplary hardware and software implementation of FIG. 15.

FIG. 23 shows, in a class diagram, a high level schema for a representative credit limit database as may be implemented in connection with the exemplary hardware and software implementation of FIG. 15.

FIG. 24 shows, in a class diagram, a high level schema for a representative principal database as may be implemented in connection with the exemplary hardware and software implementation of FIG. 1.

FIG. 25 shows, in a class diagram, a high level schema for a representative fees and Finance Charges database as may be implemented in connection with the exemplary hardware and software implementation of FIG. 15.

FIG. 26 shows, in a class diagram, a high level schema for a representative payment database as may be implemented in connection with the exemplary hardware and software implementation of FIG. 15.

FIG. 27 shows, in a class diagram, a high level schema for a representative sales transaction database as may be implemented in connection with the exemplary hardware and software implementation of FIG. 15.

### DETAILED DESCRIPTION

Just like with traditional credit account, the “innovative” credit account use Revolving Credit, Billing Cycle, Billing Cycle Begin Date, Billing Cycle End Date, Grace Period, Purchases, Fees, Finance Charges and Payments in maintaining the credit account. In a traditional credit account, the payment, finance charges and fees are calculated for the total outstanding balance by consumers. But in an “innovative” credit account of the present invention, payments, finance charges, and fees are calculated for each individual purchase and are tracked by each individual merchant.

Just like with traditional credit accounts, the innovative credit account also can be integrated with debit cards. Consumers using debit cards would make the payment in advance of purchases. In traditional debit cards the pre-paid amount will be held by financial institutions or by the single merchant issuing the credit card. Whereas in innovative credit account, the pre-paid amount will be held by the administrator of the innovative credit account.

Revolving credit is a type of credit that does not have a fixed number of payments. It is basically an arrangement which allows for the loan amount to be withdrawn, repaid, and redrawn again in any manner and any number of times, until the arrangement expires.

Credit cards are an example of revolving credit used by consumers. These are typical characteristics of credit card loans: the borrower may use or withdraw funds up to a pre-approved credit limit; the amount of available credit decreases and increases as funds are borrowed and then repaid; the credit may be used repeatedly; the borrower makes payments based only on the amount actually used or withdrawn, plus interest; and the borrower may repay over time (subject to any minimum payment requirement), or in fill at any time.

A “billing cycle” is the period of time between billings. Billings are used to provide the details of account activities to consumers. A billing cycle may start on the first day of the month and end on the last day of the month. Or, it may go from the fifteenth of one month to the fifteenth of the next. Billing cycles are of varying lengths depending on the credit card issuer.

During the billing cycle, purchases, credits, fees, and finance charges are posted to the revolving credit account. At the end of the billing cycle, the end user is billed for all unpaid charges and fees made during the billing cycle. The payment for the revolving credit account is due after a number of days, usually fifteen days after the billing cycle ends. The period of time between billing cycle end date and bill due date is known as the “grace period.”

A “finance charge” is an interest fee charged on revolving credit accounts. Finance charges are calculated using an annual percentage rate (APR) and the balance.

Different methods are used in calculating finance charges. The most commonly used method is the average daily balance method which applies the APR to an average of balance each day during the billing cycle.

In addition to finance charges, additional fees may also be imposed, if a minimum payment is not received by the service provider within minimum due date. Any method that can be used to calculate finance charges with traditional credit account can also be used with innovative credit account with one exception that the each purchase, its associated fees, finance charges and payments are tracked separately by the associated merchant rather than tracked by the whole credit account.

To better understand the differences between the traditional credit account and the innovative credit account, six methods used to calculate the finance charges in both accounts are given below:

### Adjusted Balance Method

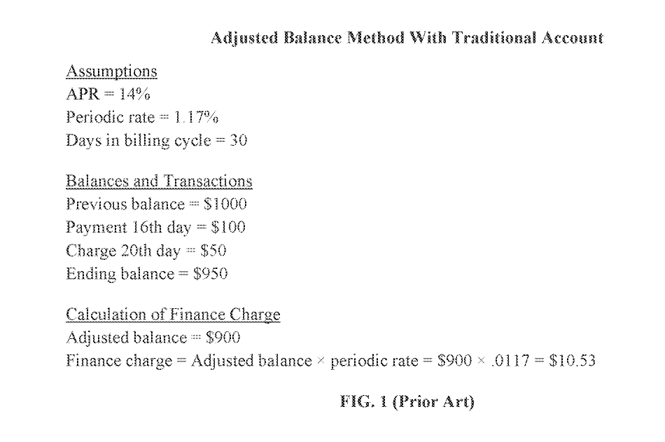

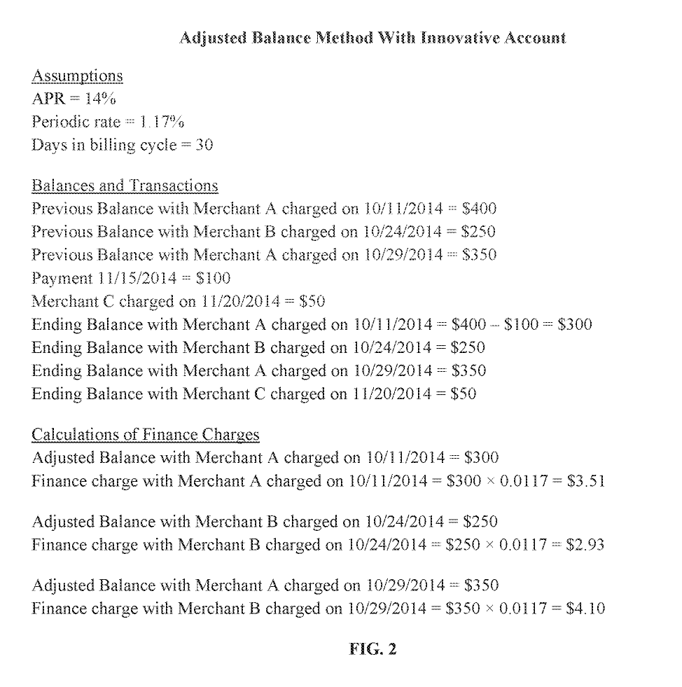

The adjusted balance method of calculating a finance charge uses the previous balance less any payments and credits made during the billing cycle. New charges are not factored into the adjusted balance. The periodic rate is applied to the adjusted balance to calculate the finance charge. FIG. 1 and FIG. 2 show implementations of a traditional account and present invention, respectively, for a 14% APR, a periodic rate of 1.17%, and a 30-day billing cycle.

### Average Daily Balance Method

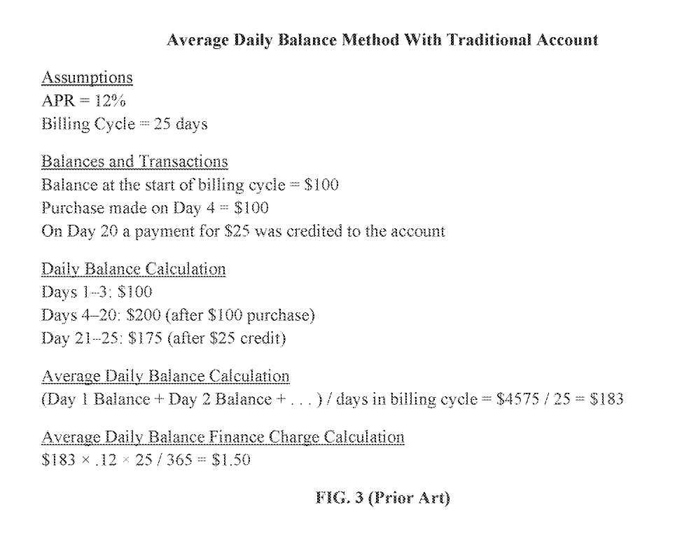

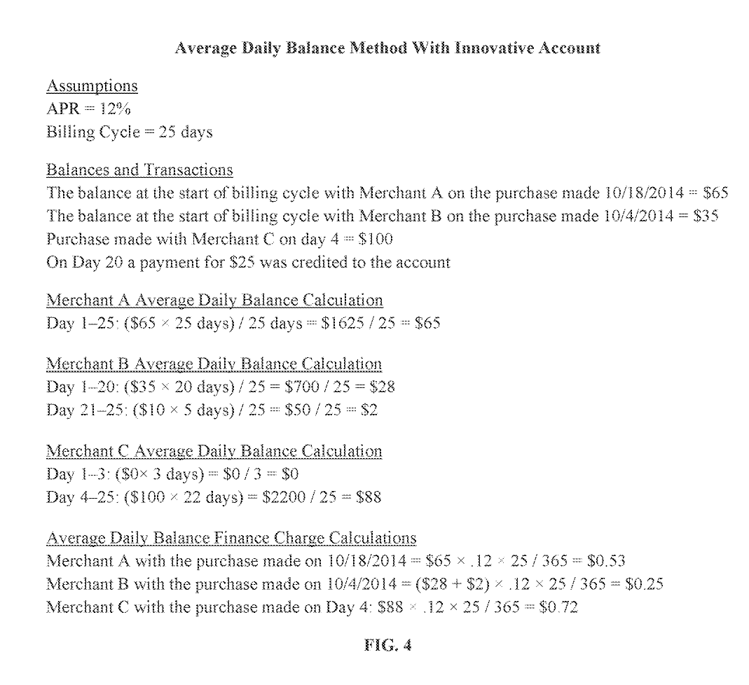

The average daily balance method of calculating finance charges uses the average daily balance during the billing cycle. Average daily balance is the sum of balance on each day of the billing divided by the number of days in the billing cycle. The calculation for the average daily balance method is average daily balance×APR×days in billing cycle/365. FIG. 3 and FIG. 4 show implementations of a traditional account and the present invention, respectively, for a 12% APR and a 25-day billing cycle.

### Daily Balance Method

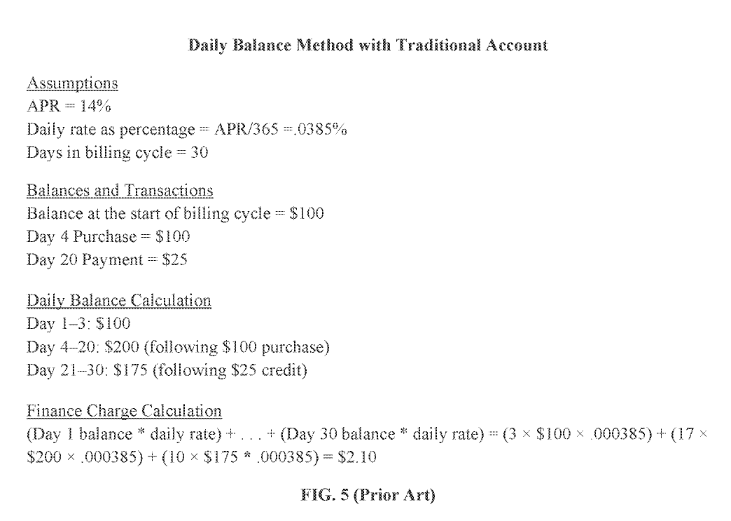

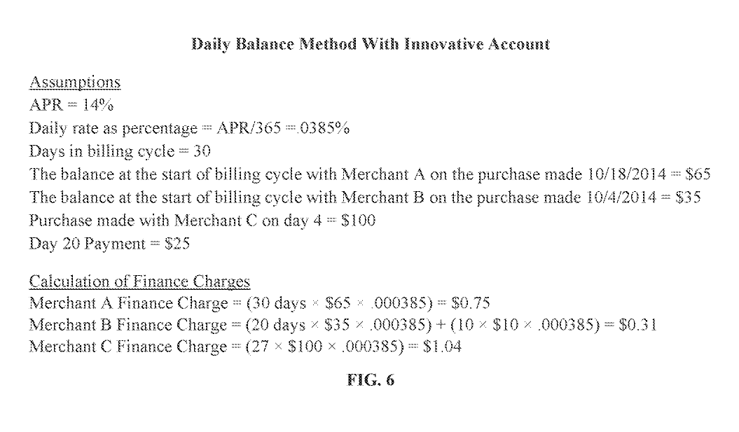

The daily balance method uses the actual balance on each day in the billing cycle. The rate applied is the daily rate, which is 1/365 of APR. Finance charges are calculated by summing each day's balance multiplied by the daily rate. FIG. 5 and FIG. 6 show implementations of a traditional account and the present invention, respectively for a 14% APR and a 30-day billing cycle.

### Double Billing Cycle Method

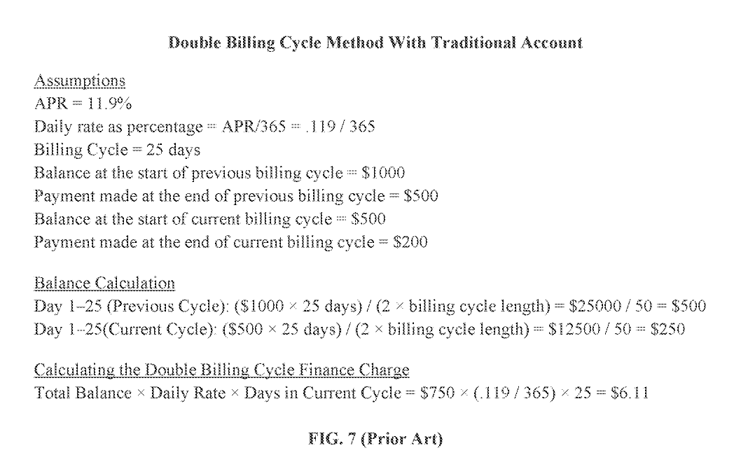

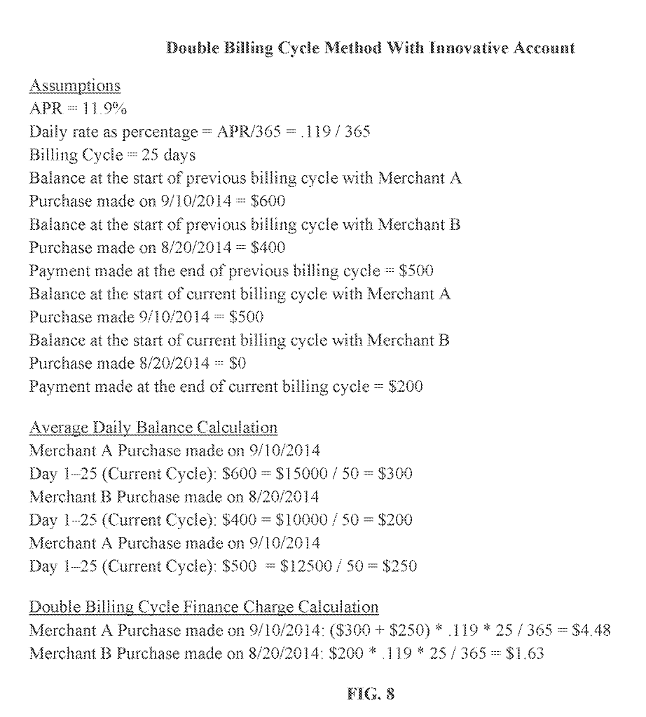

The double billing cycle method uses the average daily balance for the current and previous billing cycles. FIG. 7 and FIG. 8 show this method used with a traditional account and the present invention, respectively, for a 11.9% APR and a 25-day billing cycle.

### Ending Balance Method

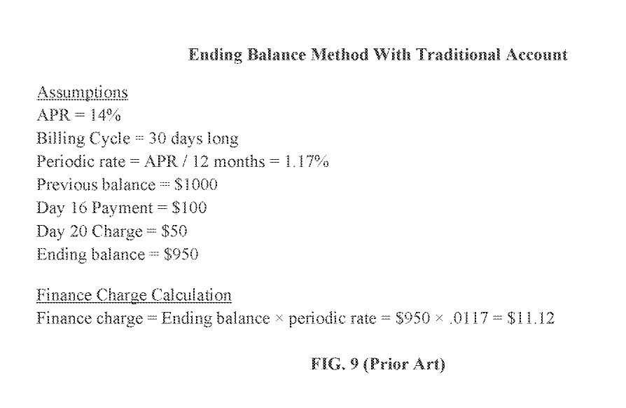

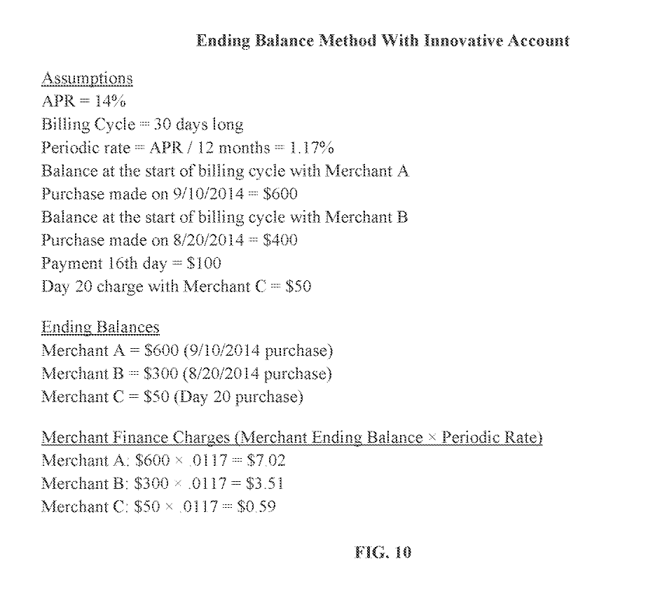

The ending balance method uses the balance at the end of the billing cycle. Beginning balance is adjusted based on payments, credits, and new charges. The periodic rate is applied to this new balance. FIGS. 9 and 10 show this method used with a traditional account and the present invention, respectively, for a 14% APR and a 30-day billing cycle.

### Previous Balance Method

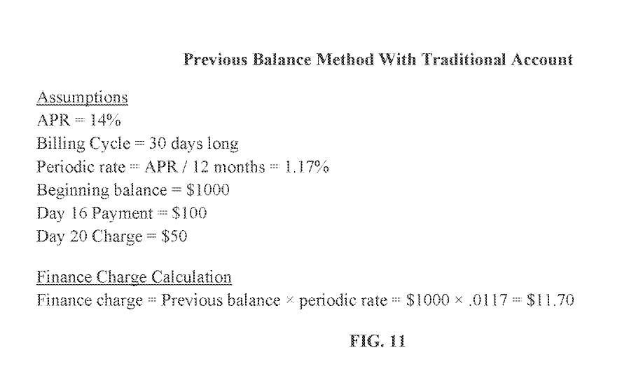

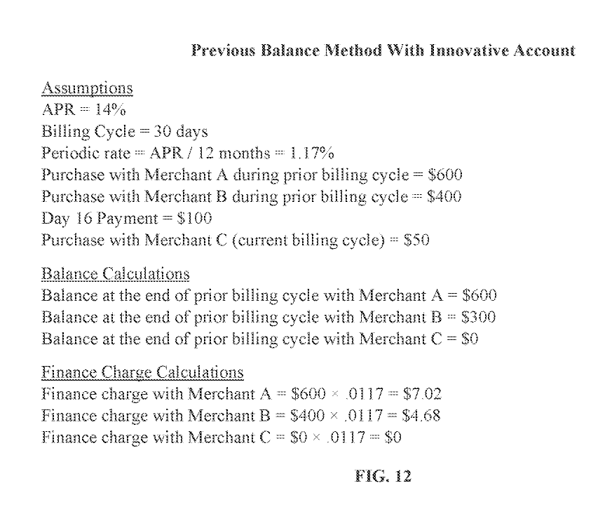

The previous balance method uses the balance at the beginning of the billing cycle. Charges applied and payments credited during the billing cycle will not affect the finance charge. FIG. 11 and FIG. 12 show this method used with a traditional account and the present invention, respectively, for a 14% APR and a 30-day billing cycle.

### Non-Performing Loans Distribution Method

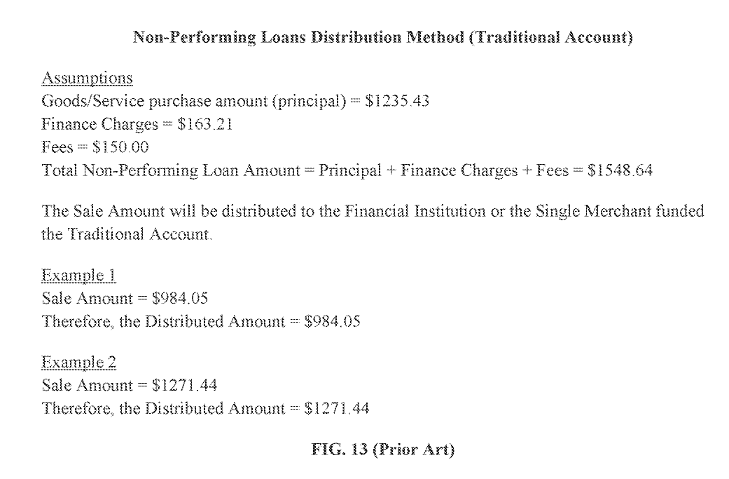

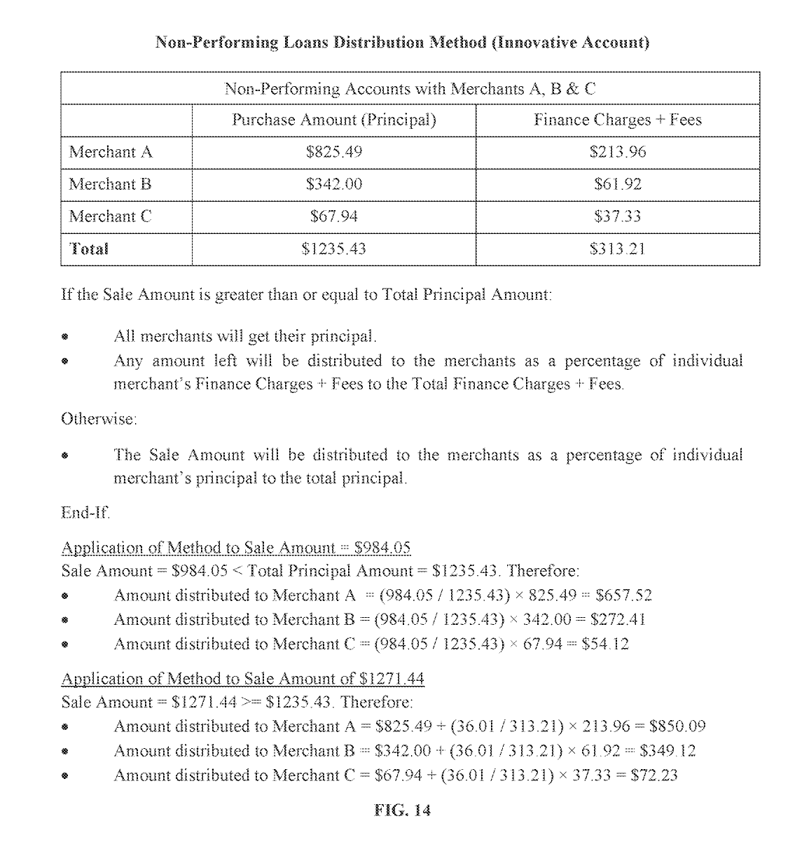

Just like with traditional credit accounts, the innovative credit account also will handle non-performing loans. The service provider may sell the non-performing loans to investors and distribute the proceeds to merchants according to each merchant's share in the non-performing loans. Any method that can be used to calculate the amount to be distributed to the entity that funded the traditional credit account can also be used with innovative credit account with one exception: that the sale amount of the non-performing loan/s are tracked separately by the associated merchant rather than tracked by the whole credit account. To better understand the differences between the traditional credit account and the innovative credit account, the method used to calculate the sale amount of non-performing loans in both accounts are given in FIG. 13 and FIG. 14, respectively.

In at least some implementations of the present invention, the participating merchants do not have to pay any discount and/or interchange fee.

In at least some implementations of the present invention the credit accounting system would be maintained by a third party entity, service provider.

In at least some implementations of the present invention, initial funding will not be required. Funding will be required only when the consumers default on their payment.

In at least some implementations of the present invention, the distribution of principal amount collected from consumers to merchants will be based on first sold first paid methodology.

In at least some implementations of the present invention, the distribution of additional fees and finance charges collected from consumers to merchants will be based on first sold first paid methodology.

In at least some implementations of the present invention, each individual sales transaction is tracked by service clients for the purposes of calculating the payment, finance charges, and fees.

In at least some implementations of the present invention, the service provider will be able to sell non-performing loans and distribute the proceeds to service clients according to each service client's share in the non-performing loans.

In at least some implementations of the present invention, the service provider will be compensated as a percentage of total sales amount and paid by respective service client that generated the sales.

In at least some implementations of the present invention, the service provider will be compensated as a fixed amount and paid by all participating service clients.

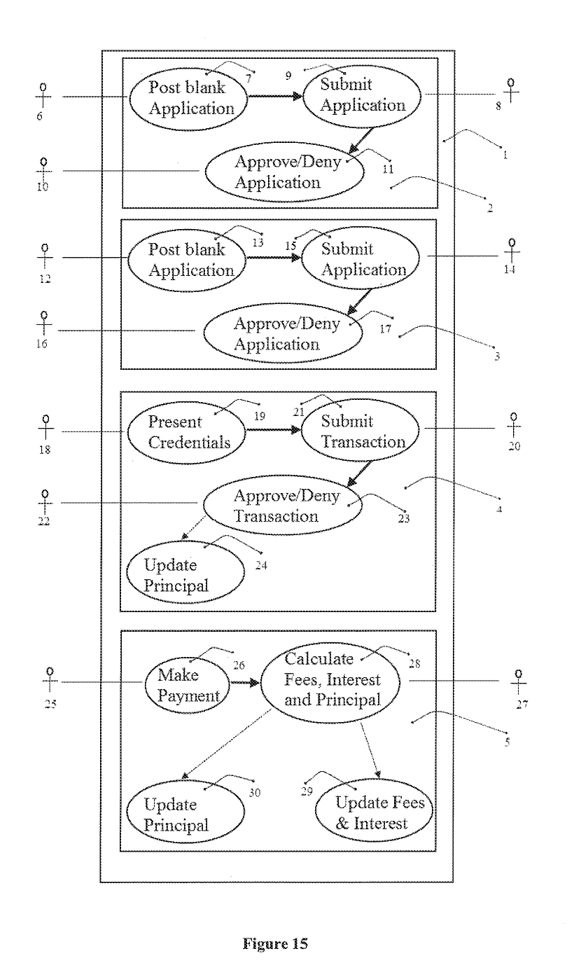

Referring to FIG. 15, the credit processing system 1 of the present invention is shown to generally comprise an operative combination of a plurality of service client implemented use cases 2, a plurality of end user implemented use cases 3 and plurality of service provider implemented use cases 4, 5. The service provider 6 of the present invention will generally provide a means 7 for service clients to receive a blank application form along with terms and conditions for the service clients to accept. The service client 8 will generally use the means 9 to submit an application. The service provider 10 will generally use the means 11 to approve or deny the service client's application.

As also shown in FIG. 15, the service provider 12 of the present invention will generally provide a means 13 for end users to receive a blank application form along with terms and conditions for the end users to accept. The end user 14 will generally use the means 15 to submit an application. The service provider 16 will generally use the means 17 to approve or deny the end user's application.

As also shown in FIG. 15, the end user 18 will generally use the means 19 to submit the credentials to the service client to pay, using the credits available in end user's account, for the products and services purchased from the service client. The service client 20 will generally use the means 21 to submit the transactions to the service provider. The service provider 22 will generally use the means 23 to approve or deny the transaction. The service provider 22, when the sales transaction is approved, will use a means 24 to calculate the principal based on the transacted amount and to update the database.

As also shown in FIG. 15, the end user 25 will use the means 26 to make payments, as per the schedule in the contract, to the service provider. The service provider 27 will generally use the means 28 to calculate the fees, Finance Charges and the principal amount. The service provider 27 will generally use the means 29 to update the fees and Finance Charges in the database. The service provider 28 will generally use the means 30 to update the principal in the database.

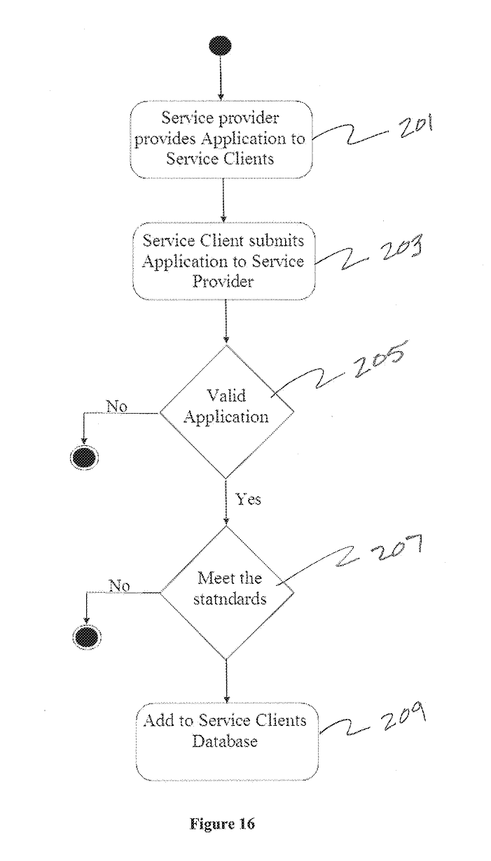

As shown in FIG. 16, the service provider would distribute the applications to prospective service clients 201. Alternatively the service provider can also post the applications where the prospective service clients can also download the applications. The service provider will evaluate the applications 205 received from prospective service clients 203 based on preset requirements. In particular, note the minimum credit score accepted by the service clients 207. Upon approval of an application the service provider would add the service clients into service client database 209. As shown in FIG. 16 the approved service clients will be added into service clients' database.

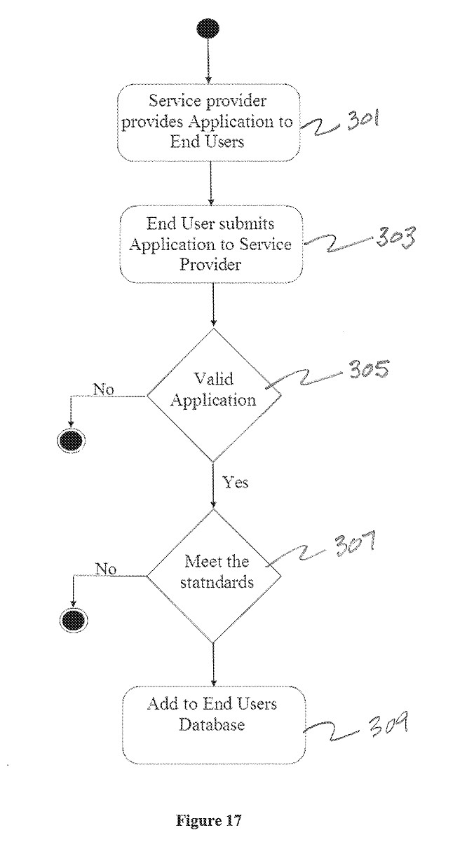

As shown in FIG. 17, the service provider would distribute the applications to prospective end users 301. Alternatively the service provider can also post the applications where the prospective end users can also download the applications. The service provider will evaluate the applications 305 received from prospective end users 303 based on preset requirements. In particular, note the credit score set for each end user 307. Upon approval of an application the service provider would add the end users into end user database 309. As shown in FIG. 17 the approved end users will be added into end users' database.

The end user will use the availability credit with any participating service client that would accept end users having a credit score above or equal to a certain credit score. So it is not guaranteed that end user will be able to use the credit limit with all the participating service clients. When the service provider 16 use the means 17 to approve or deny an end user's application, the service provider would make the decision based on end user's credit score. Also the service provider would calculate the credit score for the end user or use a credit score assigned by third party credit agencies. The credit score would also depend on the end user's credit limit. The credit score will be saved in the end user's database. The lower the credit score, the fewer service clients would accept the end users.

The service client will accept the credits from end users whose credit score is equal or above certain level. At the time of submitting application the service client would select the minimum credit score that the service client would accept. This minimum credit score limit can be modified by the service clients by submitting a request to the service provider. The blank application posted by the service provider 6, as shown in FIG. 15, for service clients will include the accepted minimum credit score. A higher minimum credit score means fewer end users will be able to purchase the service and goods from the service clients with their credits.

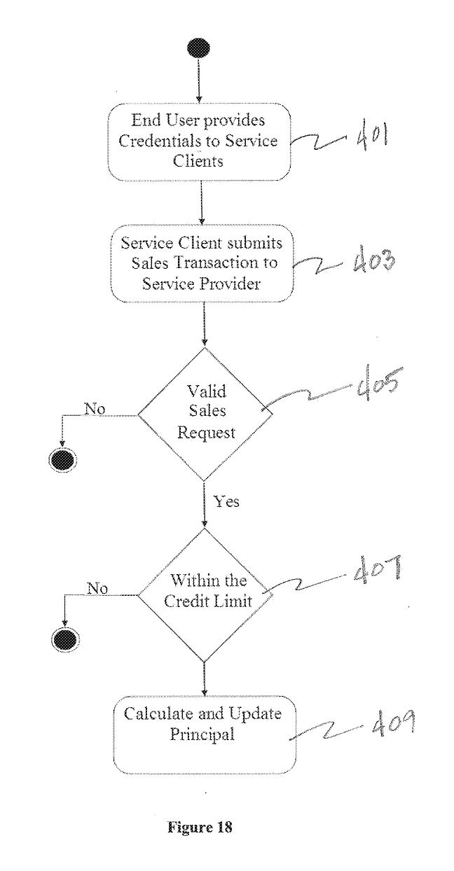

As particularly shown in FIG. 18, the sales transaction using the available credit starts with end user submitting the credentials to the service client 401. If the submitted credential 403 is valid 405 and if the requested credit amount is available without exceeding the credit limit 407 then the request will be approved. When the request is approved the service provider would add the credit amount to the principal and update the same in the database 409.

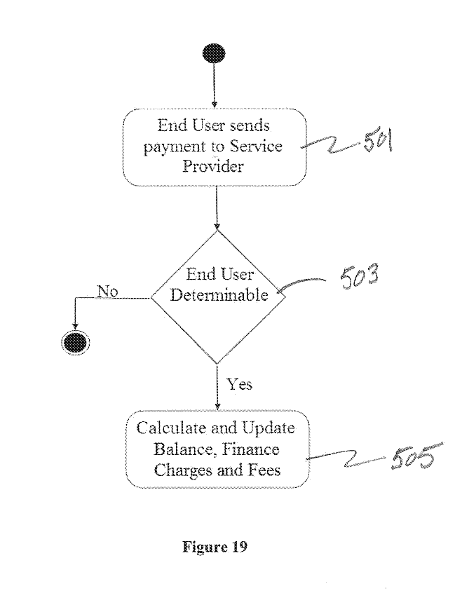

As particularly shown in FIG. 19, the payment transaction starts with the end user making a payment to the service provider 501. The service provider would apply the payment for Finance Charges and fees as well as for principal of each individual sales transaction starting from the earliest sales transaction that has not been fully paid. Then the service provider would calculate the Finance Charges and fees for the sales transactions that have not been fully paid 505.

Although those of ordinary skill in the art will readily recognize many alternative methods and systems in calculating and updating the database for payment, Finance Charges and fees, especially in light of the illustrations provided herein, the detailed method and system is exemplary of the preferred method and system of the present invention. The detailed method and system maintains payment, Finance Charges and fees for each individual sales transaction rather than for all the sales transactions combined together.

The service provider would select a certain date in a month as ‘Billing Cycle Begin Date’. If the ‘Billing Cycle Begin Date’ does not exist in a month—for example, 31 does not exist in February, April, June, September and November—then the last date in the month will be the ‘Billing Cycle Begin Date’.

The service provider would select a day before the ‘Billing Cycle Begin Date’ of the next Billing Cycle as ‘Billing Cycle End Date’.

The service provider would select a day in between the next ‘Billing Cycle Begin Date’ and ‘Billing Cycle End Date’ as ‘Minimum Payment Due Date’. The service provider would add a pre-determined grace period in days to the current ‘Billing Cycle End Date’ to calculate the ‘Minimum Payment Due Date’.

The service provider would calculate the ‘Minimum Payment’ for each individual sales transaction that has not been fully paid as of the ‘Billing Cycle End Date’. The ‘Minimum Payment’ would include Finance Charges, fees and principal amount. The ‘Minimum Payment’ would be calculated on the basis that the end user would make the payment over an extended period of time. The Finance Charges amount would depend on the annual percentage rate (APR) as per the contract with the end user, the sales transaction date, the sales transaction balance and the finance charge calculation method. The fees would depend on whether ‘Minimum Payment’ of the previous period has been paid or not. If all the Finance Charges, fees and principal amount of all sales transaction have been fully paid as of the previous ‘Minimum Payment Due Date’ then there will not be any Finance Charges or fees.

The service provider would update the calculated Finance Charges, fees and principal in the database 605.

The service provider would calculate the ‘Total Minimum Payment’ by adding ‘Minimum Payment’ of all sales transactions.

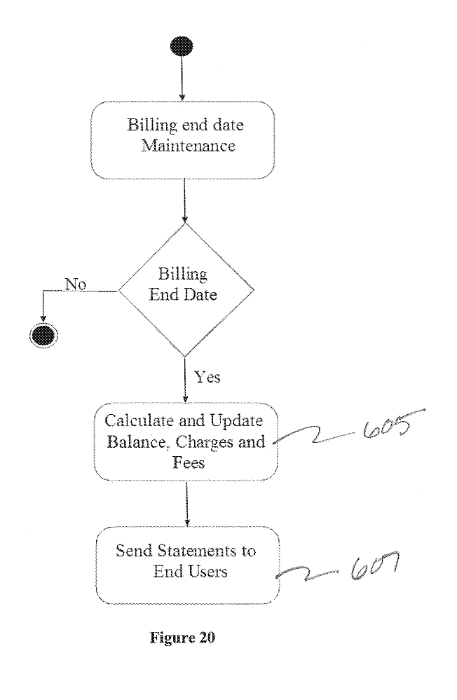

As shown in FIG. 20, the service provider would send a statement for each period to the end user 607. At a minimum the statement would include ‘Billing Cycle Begin Date’, ‘Billing Cycle End Date’, ‘Total Finance Charges’, ‘Total Fees’ and details of all sales transactions within the ‘Billing Cycle Begin Date’ and ‘Billing Cycle End Date’.

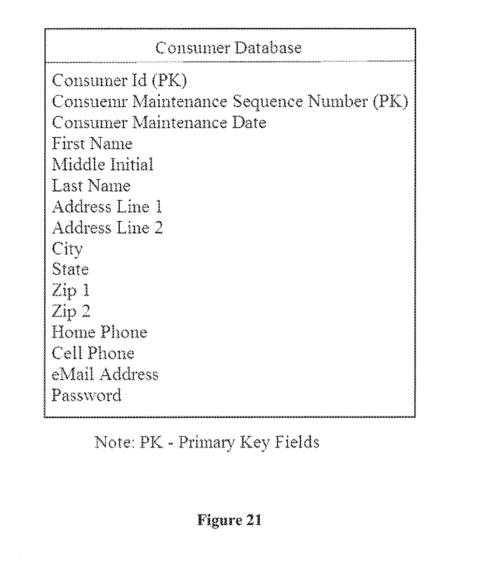

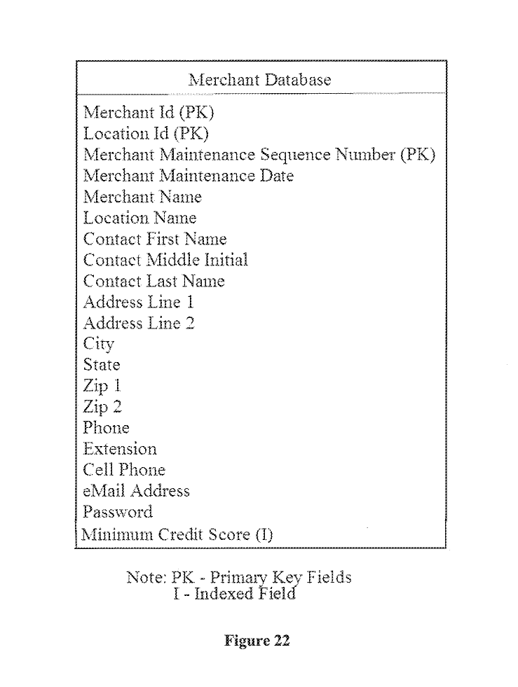

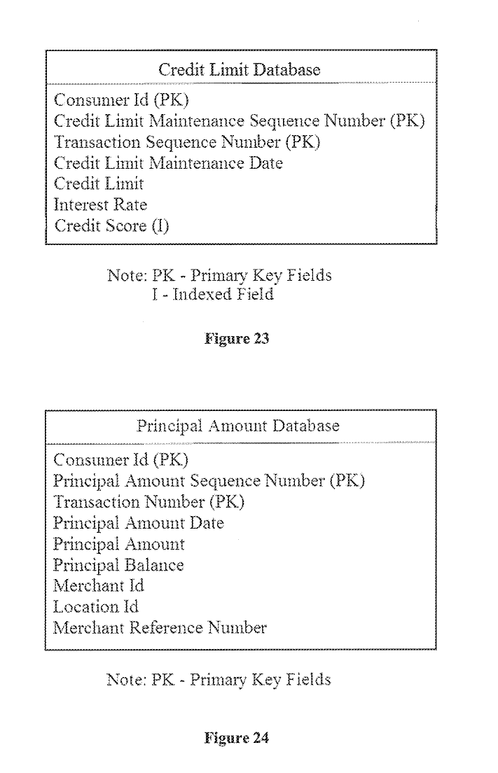

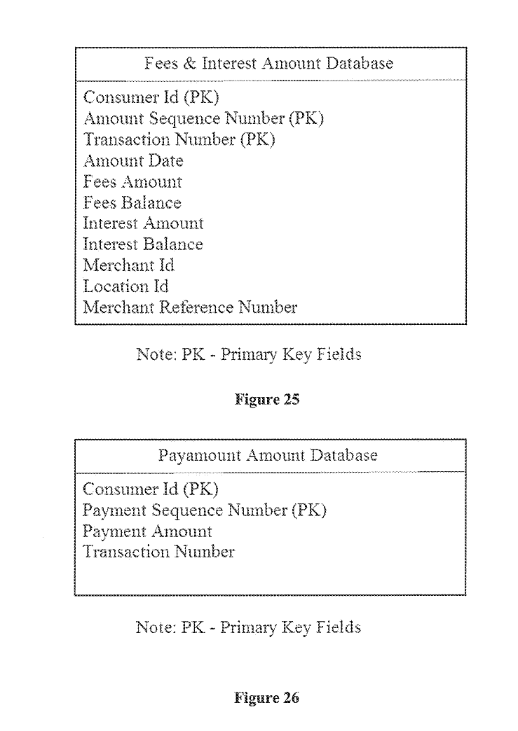

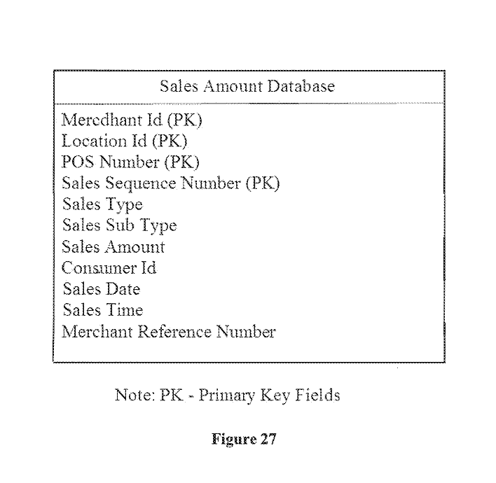

Through various embodiments of the present invention, a number of databases may be employed, including those illustrated in FIG. 21 (Consumer Database); FIG. 22 (Merchant Database); FIG. 23 (Credit Limit Database); FIG. 24 (Principal Amount Database); FIG. 25 (Fees & Interest Amount Database); FIG. 26 (Payamount Amount Database); FIG. 27 (Sales Amount Database).

In any case, because the scope of the present invention is, much broader than any particular embodiment, the foregoing detailed description should not be construed as a limitation of the scope of the present invention, which is limited only by the claims appended hereto.

I claim:

1. A method of managing a revolving credit account that has been accepted and funded by a plurality of service clients, the method comprising the steps of:
accepting and evaluating applications from potential service clients;
approving the potential service clients into the revolving credit account as an approved service client;
accepting and evaluating applications from potential end users of the revolving credit account;
approving the potential end users into the revolving credit account as approved end users;
adding the approved end users into the revolving credit account;
setting up a credit limit for each approved end user;
setting up a payment plan for each approved end user, said payment plan including a billing cycles, a grace periods, a payment schedule, and an annual percentage rate for calculating finance charges;
deciding whether to approve or deny request for payment by service clients for products and services sold to end users;
accepting payments from approved end users for the cost of products or services bought by end users from service clients, any accumulated finance charges, and any fees;
distributing the payment to service clients, said distribution is based on conditions set forth between service provider and service clients.
